(19) United States
(12) Patent Application Publication
(10) Pub. No.: US 2024/0326635 A1
(43) Pub. Date: Oct. 3, 2024

(54) SERVER DEVICE

(71) Applicant: TOYOTA JIDOSHA KABUSHIKI KAISHA, Toyota-shi (JP)

(72) Inventors: Takahiro AOKI, Saitama-shi (JP); Yuta TAKATA, Toyota-shi (JP); Haruki OGURI, Toyota-shi (JP); Takashi YAMAZAKI, Nagoya-shi (JP); Tsuyoshi OKADA, Nagoya-shi (JP); Hiroki ASAO, Kobe-shi (JP)

(73) Assignee: TOYOTA JIDOSHA KABUSHIKI KAISHA, Toyota-shi (JP)

(21) Appl. No.: 18/422,317

(22) Filed: Jan. 25, 2024

(30) Foreign Application Priority Data
Mar. 29, 2023 (JP) 2023-053819

(51) Int. Cl. B60L 53/68; B60L 53/66; G06Q 10/20; G06Q 20/14

(52) U.S. Cl. CPC B60L 53/68; B60L 53/665; G06Q 10/20; G06Q 20/14

(57) ABSTRACT

The server device includes a communication unit and a control unit that performs communication using the communication unit, and the control unit is configured to provide power when power is supplied to the power-supplied vehicle from a terminal device within a predetermined range including the power-supplied vehicle. When information requesting a possible service is received, a power supply vehicle that can provide the service and can supply power to the power supplied vehicle is instructed to move for power supply.

### CROSS-REFERENCE TO RELATED APPLICATION

This application claims priority to Japanese Patent Application No. 2023-053819 filed on Mar. 29, 2023, incorporated herein by reference in its entirety.

### BACKGROUND

### 1. Technical Field

The present disclosure relates to a server device.

### 2. Description of Related Art

A battery electric vehicle (BEV) or the like driven by a battery occasionally runs out of electric power, that is, runs out of power, while moving. Various techniques have been proposed to resolve or avoid such a situation. For example, Japanese Unexamined Patent Application Publication No. 2019-093968 (JP 2019-093968 A) discloses a technique of charging a vehicle running out of power from another vehicle.

### SUMMARY

There is room for businesses to improve the efficiency of the operation of power supply vehicles in businesses that arrange power supply vehicles to vehicles that are out of power and use the power supply vehicles to supply power.

The present disclosure provides a server device or the like that is able to improve the operation rate of power supply vehicles.

A server device according to the present disclosure includes a communication unit, and a control unit that performs communication using the communication unit. The control unit instructs, when the control unit receives information requesting a service that is able to be provided along with power supply to a power-supplied vehicle from a terminal device within a predetermined range including the power-supplied vehicle, a power supply vehicle that is able to supply power to the power-supplied vehicle and that is able to provide the service to move for power supply.

According to the server device or the like of the present disclosure, it is possible to improve the operation rate of power supply vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of the configuration of a vehicle management system; and

FIG. 2 is a diagram illustrating an example of the operation procedure of the server device, the power supply vehicle, and the terminal device.

### DETAILED DESCRIPTION OF EMBODIMENTS

Embodiments will be described below with reference to the drawings.

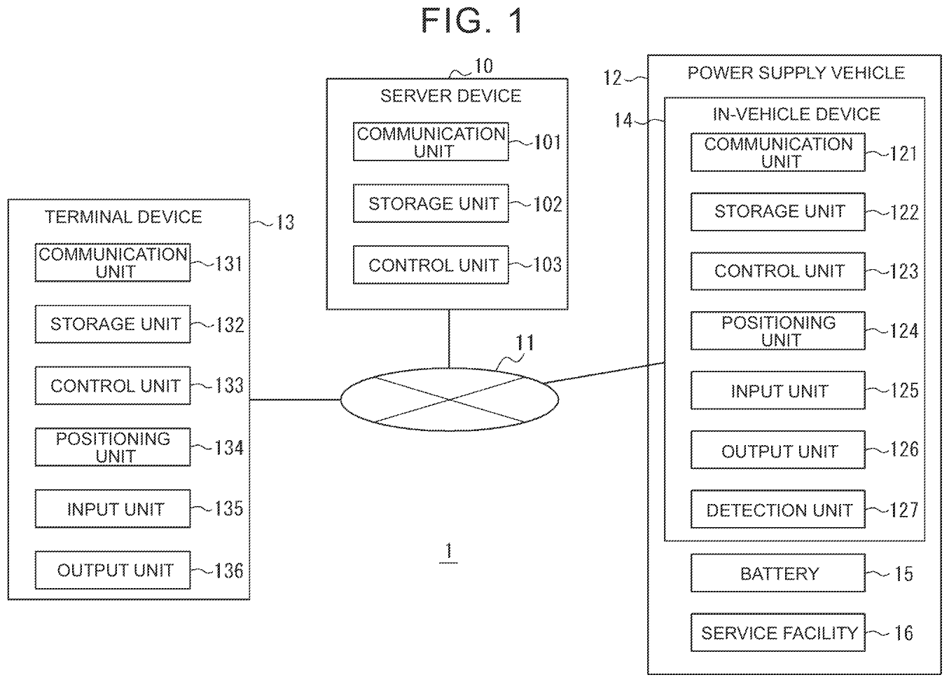

FIG. 1 is a diagram showing a configuration example of a vehicle management system in one embodiment. The vehicle management system 1 includes one or more server devices 10, one or more power supply vehicles 12, and one or more terminal devices 13. The server device 10, the power supply vehicle 12, and the terminal device 13 are connected to each other via the network 11 so that they can communicate information.

The server device 10 is, for example, a server computer belonging to a cloud computing system or other computing systems and functioning as a server implemented with various functions.

The power supply vehicle 12 is a passenger car or a commercial vehicle equipped with a communication function and an information processing function, and is connected to the network 11 via a mobile communication network. The power supply vehicle 12 is equipped with a battery 15 as a power source for supplying power to another vehicle in a power-deficient state (hereinafter referred to as a power-deficient vehicle). The power supply vehicle 12 is, for example, a gasoline vehicle, or a battery electric vehicle (BEV), a hybrid electric vehicle (HEV), a plug-in hybrid electric vehicle (PHEV), or a fuel cell electric vehicle (FCEV), etc. that is driven by the electric power of the installed battery 15, for example. The power supply vehicle 12 may be driven by a driver, or may be driven at any level of automation. The power supply vehicle 12 further includes a service facility 16 for providing various services to users of the power-out vehicle or users around the power-out vehicle.

The terminal device 13 is an information processing device equipped with a communication function. The terminal device 13 executes various information communications and information processing used by the user of the power-supplied vehicle or the users around the power-supplied vehicle that has fallen into a power outage state. The terminal device 13 is, for example, an information processing terminal such as a smartphone, a tablet terminal, or a personal computer. The terminal device 13 may be part or all of an in-vehicle device installed in a vehicle without electricity.

The network 11 is, for example, the Internet, but includes an ad hoc network, a local area network (LAN), a metropolitan area network (MAN), another network, or a combination thereof.

In the present embodiment, the vehicle management system 1 allows the power supply vehicle 12 to rush to charge the vehicle that is out of power when the power-supplied vehicle, such as a BEV, HEV, or PHEV, falls into a power outage state and becomes a power outage vehicle. It is a system to support. The power shortage state may be a state in which the remaining battery capacity of the power-supplied vehicle has decreased to such an extent that one or more operations including running of the power-supplied vehicle cannot be performed, a state in which the remaining battery level has fallen below an arbitrary level, or a state in which the user of the power-supplied vehicle arbitrarily determines that power supply is necessary. Rush charging is a mode in which power is supplied by moving the power supply vehicle 12 to the position of the vehicle that is out of power (hereinafter referred to as the power supply position) and charging the battery of the power-supplied vehicle from the battery 15 of the power supply vehicle 12. In the vehicle management system 1, one or more power supply vehicles 12 perform rush power feeding under the control of the server device 10.

The server device 10 includes a communication unit 101 and a control unit 103 that performs communication using the communication unit 101. When the control unit 103 receives information requesting a service that can be provided in conjunction with power supply to the power-supplied vehicle from the terminal device 13 within a predetermined range including a vehicle that is out of power, the control unit 103 instructs the power supply vehicle 12 that can supply power to the power-supplied vehicle and that can provide the service to move for power supply. The power supply vehicle 12 becomes possible to provide services such as maintenance and an inspection of the power-supplied vehicle to users of the power-supplied vehicle during the power supply time when supplying power to the power-supplied vehicle, and to provide services such as ride sharing to users around the power-supplied vehicle when returning after power supply. Therefore, a business that performs on-demand charging using the power supply vehicle 12 can receive compensation for services other than power feeding, and thus it is possible to improve the operating rate of the power supply vehicle 12.

Next, a configuration example of the server device 10, the power supply vehicle 12, and the terminal device 13 will be described.

The server device 10 includes a communication unit 101, a storage unit 102, and a control unit 103. The server device 10 may be one computer, or may be composed of two or more computers that are connected to enable information communication and operate in cooperation. When the server device 10 is composed of two or more computers, the configuration shown in FIG. 1 is appropriately arranged on the two or more computers. Communication unit 101 includes one or more communication interfaces.

The communication interface is, for example, a LAN interface. The communication unit 101 receives information used for the operation of the control unit 103 and transmits information obtained by the operation of the control unit 103. The server device 10 is connected to the network 11 by a communication unit 101 and performs information communication with the power supply vehicle 12 and the terminal device 13 via the network 11.

The storage unit 102 includes, for example, one or more semiconductor memories, one or more magnetic memories, one or more optical memories, or a combination of at least two of these, which function as a main storage device, an auxiliary storage device, or a cache memory. The semiconductor memory is, for example, Random Access Memory (RAM) or Read Only Memory (ROM). The RAM is, for example, Static RAM (SRAM) or Dynamic RAM (DRAM). The ROM is, for example, an electrically erasable programmable ROM (EEPROM). The storage unit 102 stores information used for the operation of the control unit 103 and information obtained by the operation of the control unit 103.

Control unit 103 includes one or more processors, one or more dedicated circuits, or a combination thereof. The processor is, for example, a general-purpose processor such as a Central Processing Unit (CPU), or a dedicated processor such as a Graphics Processing Unit (GPU) specialized for specific processing. The dedicated circuit is, for example, a Field-Programmable Gate Array (FPGA), an Application Specific Integrated Circuit (ASIC), or the like. The control unit 103 executes information processing related to the operation of the server device 10 while controlling each part of the server device 10.

The functions of the server device 10 are realized by executing a control program by a processor included in the control unit 103. The control program is a program that causes the computer to execute the processing of steps included in the operation of the server device 10, thereby causing the computer to realize functions corresponding to the processing of the steps. That is, the control program is a program for causing the computer to function as the server device 10. Furthermore, some or all of the functions of the server device 10 may be realized by a dedicated circuit included in the control unit 103. Further, the control program may be stored in a non-transitory recording/storage medium that can be read by the server device 10, and the server device 10 may read the control program from the medium.

The power supply vehicle 12 includes an in-vehicle device 14, a battery 15, and a service facility 16. The in-vehicle device 14 includes a communication unit 121, a storage unit 122, a control unit 123, a positioning unit 124, an input unit 125, an output unit 126, and a detection unit 127. One or more of these parts may be configured as one control device, or may be configured as a personal computer including a tablet terminal, a smartphone, a navigation device, etc. Alternatively, each part may be connected to enable information communication via an in-vehicle network compliant with standards such as Controller Area Network (CAN). The battery 15 is a battery that charges and discharges power for supplying power to a vehicle running out of power. Further, the battery 15 may include a battery that charges and discharges power for driving the power supply vehicle 12. Battery 15 is, for example, one or more lithium ion batteries. The service facilities 16 include equipment and equipment for providing services other than power supply, such as an inspection and maintenance of vehicles that are out of power, and living spaces for providing ride sharing as a service.

The communication unit 121 includes one or more communication interfaces. The communication interface is, for example, an interface compatible with mobile communication standards such as Long Term Evolution (LTE), 4th Generation (4-G), or 5th Generation (5G). The communication unit 121 receives information used for the operation of the control unit 123 and transmits information obtained by the operation of the control unit 123. The control unit 123 is connected to the network 11 via a mobile communication base station by the communication unit 121, and performs information communication with the server device 10 and the like via the network 11.

The storage unit 122 includes one or more semiconductor memories, one or more magnetic memories, one or more optical memories, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 122 functions as, for example, a main storage device, an auxiliary storage device, or a cache memory. The storage unit 122 stores information used for the operation of the control unit 123 and information obtained by the operation of the control unit 123.

Control unit 123 includes one or more processors, one or more dedicated circuits, or a combination thereof. The processor is a general-purpose processor such as a CPU or a dedicated processor specialized for specific processing. The dedicated circuit is, for example, an FPGA or an ASIC. The control unit 123 executes information processing related to the operation of the power supply vehicle 12 while controlling each unit of the in-vehicle device 14.

The positioning unit 124 includes one or more Global Navigation Satellite System (GNSS) receivers. GNSS includes, for example, at least one of Global Positioning System (GPS), Quasi-Zenith Satellite System (QZSS), BeiDou, Global Navigation Satellite System (GLONASS), and Galileo. The positioning unit 124 acquires position information of the power supply vehicle 12.

The input unit 125 includes one or more input interfaces. The input interface is, for example, a physical key, a capacitive key, a pointing device, a touch screen integrated with a display, or a microphone that receives voice input. The input interface may further include a camera that captures images or image codes, or an IC card reader. The input unit 125 accepts an operation to input information used for the operation of the control unit 123 and sends the input information to the control unit 123.

The output unit 126 includes one or more output interfaces. The output interface is, for example, a display or a speaker. The display is, for example, a Liquid Crystal Display (LCD) or an organic Electro-Luminescence (EL) display. The output unit 126 outputs information obtained by the operation of the control unit 123.

The detection unit 127 has an interface with one or more sensors that detects the state of each part of the power supply vehicle 12, or one or more sensors. The sensors include, for example, a sensor that detects the remaining battery level of the battery 15, a sensor that detects the motion state (speed, longitudinal acceleration, lateral acceleration, deceleration, etc.) of the power supply vehicle 12, and the like. The detection unit 127 sends information indicating each state detected by the sensor to the control unit 123.

The functions of the control unit 123 are realized by executing a control program with a processor included in the control unit 123. The control program is a program that causes the computer to execute the processing of the steps included in the operation of the control unit 123, thereby causing the computer to realize a function corresponding to the processing of the steps. That is, the control program is a program for causing the computer to function as the control unit 123. Further, some or all of the functions of the control unit 123 may be realized by a dedicated circuit included in the control unit 123.

The terminal device 13 is, for example, an information processing device such as a smartphone or a tablet terminal, or an information processing device that constitutes part or all of an in-vehicle device installed in a vehicle without power. The terminal device 13 includes a communication unit 131, a storage unit 132, a control unit 133, a positioning unit 134, an input unit 135, and an output unit 136.

The communication unit 131 includes a communication module compatible with wired or wireless LAN standards, a module compatible with mobile communication standards such as LTE, 4G, or 5G. The terminal device 13 is connected to the network 11 by a communication unit 131 via a nearby router device or a mobile communication base station, and performs information communication with the server device 10 and the like via the network 11.

The storage unit 132 includes one or more semiconductor memories, one or more magnetic memories, one or more optical memories, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 132 functions as, for example, a main storage device, an auxiliary storage device, or a cache memory. The storage unit 132 stores information used for the operation of the control unit 133 and information obtained by the operation of the control unit 133.

The control unit 133 includes, for example, one or more general-purpose processors such as a CPU or a Micro Processing Unit (MPU), or one or more dedicated processors specialized for specific processing. Alternatively, the control unit 133 may include one or more dedicated circuits such as FPGA or ASIC. The control unit 133 comprehensively controls the operation of the terminal device 13 by operating according to a control/processing program or according to an operation procedure implemented as a circuit. The control unit 133 transmits and receives various information to and from the server device 10 and the like via the communication unit 131, and executes operations according to the present embodiment.

The positioning unit 134 includes one or more GNSS receivers. The GNSS includes, for example, at least one of GPS, QZSS, BeiDou, GLONASS, and Galileo. The positioning unit 134 acquires position information of the terminal device 13.

The input unit 135 includes one or more input interfaces. The input interface is, for example, a physical key, a capacitive key, a pointing device, a touch screen integrated with a display, or a microphone that receives voice input. The input interface may further include a camera that captures images or image codes, or an IC card reader. The input unit 135 accepts an operation to input information used for the operation of the control unit 133 and sends the input information to the control unit 133.

The output unit 136 includes one or more output interfaces. The output interface is, for example, a display or a speaker. The display is, for example, an LCD or an organic EL display. The output unit 136 outputs information obtained by the operation of the control unit 133.

The functions of the control unit 133 are realized by a processor included in the control unit 133 executing a control program. The control program is a program for causing the processor to function as the control unit 133. Further, some or all of the functions of the control unit 133 may be realized by a dedicated circuit included in the control unit 133.

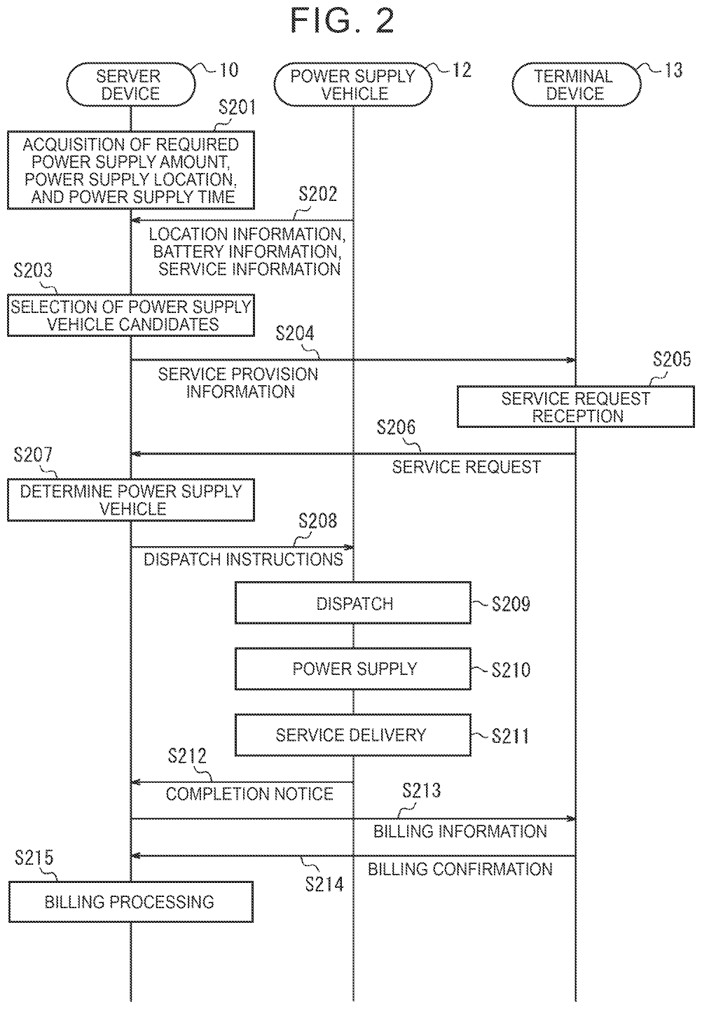

FIG. 2 is a sequence diagram showing an example of a procedure for cooperative operation of the server device 10, the power supply vehicle 12, and the terminal device 13. Steps related to various information processing by the server device 10, the power supply vehicle 12, and the terminal device 13 in FIG. 2 are executed by the respective control units 103, 123, and 133. In addition, the steps related to the transmission and reception of various information between the server device 10, the power supply vehicle 12, and the terminal device 13 are executed by the respective control units 103, 123, and 133 transmitting and receiving information to each other via the communication units 101, 121, and 131, respectively. In the server device 10, the power supply vehicle 12, and the terminal device 13, the control units 103, 123, and 133 store information to be processed, transmitted, and received, respectively, in the storage units 102, 122, and 132 as appropriate.

The procedure in FIG. 2 is an example of a procedure when the server device 10 dispatches the power supply vehicle 12 for emergency charging. The procedure in FIG. 2 is executed, for example, when the server device 10 receives a power supply request from a power-depleted vehicle equipped with information communication and information processing functions.

In S201, the server device 10 acquires the required power supply amount, power supply position, and power supply time. The server device 10 sends information requesting such information to the power-supplied vehicle, and acquires information sent from the power-supplied vehicle in response. The required power supply amount is the amount of power required to reach an arbitrary standard remaining amount in the power-supplied vehicle, and is transmitted from the power-supplied vehicle. The arbitrary reference remaining amount is, for example, an arbitrary State of Charge (SOC) value from 80 to 100%. The power supply position is the current position of the power-supplied vehicle or a position specified by the user of the power-supplied vehicle. The power supply time is the time at which power supply should start, specified by the user of the power-supplied vehicle. The power supply time may be, for example, a time that is moved forward by an arbitrary required power supply time from the scheduled travel start time set for the power-supplied vehicle.

When the server device 10 receives power supply requests from a plurality of power-supplied vehicles, it identifies one power-supplied vehicle using an arbitrary algorithm, and executes the procedures from S202 onwards. For example, the power-supplied vehicle that sent the power supply request first, or the power-supplied vehicle that requires the most or least amount of power to be supplied is specified.

In S202, the server device 10 acquires location information, battery information, and service information from one or more power supply vehicles 12. The server device 10 requests position information, battery information, and service information for each power supply vehicle 12 from one or more power supply vehicles 12, and acquires information sent from each power supply vehicle 12 in response to the request. The battery information includes information regarding the remaining capacity and power supply capacity of the battery 15. The remaining amount of the battery 15 is, for example, an SOC value. The power supply capacity is, for example, an output current per unit time. The service information is information regarding service items and their fees that can be provided by the service facility 16, and includes, for example, items such as types of vehicle inspection/maintenance, ride sharing, etc.

In S203, the server device 10 selects the power supply vehicle 12 to perform emergency charging. For example, the server device 10 selects a power supply vehicle 12 whose remaining battery level is equal to or greater than the required power supply amount within an arbitrary distance range from the power supply position. The arbitrary distance range is, for example, a distance range in which the vehicle can reach the power supply position by the power supply time when moving at a legal speed. Furthermore, the server device 10 derive the required time until the remaining battery level of the power-supplied vehicle reaches or exceeds an arbitrary standard based on the required power supply amount of the power-supplied vehicle and the power supply capacity of the battery 15 of the power supply vehicle 12 selected as a candidate. The standard is, for example, an arbitrary SOC value between 80% and 100%. Then, among the power supply vehicles 12 selected as candidates, power supply vehicles 12 having service items that can be provided during the power supply time are selected. When a plurality of power supply vehicles 12 are selected as candidates, the server device 10 prioritizes the power supply vehicles 12 based on arbitrary criteria. For example, priority is given in order of proximity to the power feeding position, order of battery remaining capacity, etc.

In S204, the server device 10 sends the service provision information to the terminal device 13 of the user of the power-supplied vehicle. The service provision information includes, for example, information of service items and fees related to maintenance and an inspection that can be provided by the power supply vehicle 12 selected as a candidate or the power supply vehicle 12 with the highest priority among the candidates during the power supply time of the power-supplied vehicle. The terminal device 13 may be an in-vehicle device of a power-supplied vehicle. For example, when receiving a power supply request from a power-supplied vehicle, the server device 10 acquires identification information of the terminal device 13, identifies the terminal device 13 based on the identification information, and sends service provision information. Alternatively, if the service items that can be provided by the power supply vehicle 12 include ride sharing, the server device 10 may send service provision information including the ride sharing fee to the terminal device 13 of users around the power-supplied vehicle. In that case, the server device 10, for example, acquires location information from the terminal device 13 of a user registered in advance with the ride sharing service, and sends service provision information to users within an arbitrary distance range of the power-supplied vehicle. Any distance range may be, for example, from hundreds of meters to several kilometers. The narrower the distance range, the more it is possible to reduce wasted time from the end of power supply to the provision of ride sharing.

In S205, the terminal device 13 accepts a service request from the user. The terminal device 13 outputs the service provision information received from the server device 10 on a display or the like to prompt the user to decide whether to request the service. When the user inputs a service request in response to this, the terminal device 13 accepts this input. Alternatively, if the user inputs an input to refuse the service, the terminal device 13 may accept this input.

In S206, the terminal device 13 sends a service request to the server device 10. Alternatively, if the service has been denied, the terminal device 13 may send information to the server device 10 that the service has been denied.

In S207, the server device 10 determines the power supply vehicle 12 to perform emergency charging on the condition that a service request is received from the terminal device 13. Note that when a plurality of power supply vehicles 12 are selected as candidates and information indicating that the service is to be refused is sent from the terminal device 13, S204 to S206 are executed for the power supply vehicle 12 with the next priority. It's okay.

In S208, the server device 10 sends a dispatch instruction to the selected power supply vehicle 12. The dispatch instruction includes information on the travel route to the power supply location and information on the service items to be provided. The movement route is, for example, a route that can reach the power supply position from the current position of the power supply vehicle 12 in the shortest distance or in the shortest time. The server device 10 derives a travel route using an arbitrary algorithm using the map information.

In S209, the power supply vehicle 12 is dispatched in response to the dispatch instruction. The power supply vehicle 12 starts moving according to the moving route. Alternatively, the power supply vehicle 12 displays the travel route to the occupant, and starts moving in response to the occupant's operation.

When the power supply vehicle 12 arrives at the power supply position, power is supplied from the power supply vehicle 12 to the power-supplied vehicle in S210. For example, the power supply vehicle 12 provides power for power supply from the battery 15 to the power-supplied vehicle through the operation of a passenger or the operation of an automatic machine.

In S211, the power supply vehicle 12 provides a service. For example, when an inspection and maintenance of the power-supplied vehicle is requested, the power supply vehicle 12 performs the inspection and maintenance of the power-supplied vehicle through the operation of a passenger or the operation of an automatic machine. Alternatively, if ride sharing is selected, the power supply vehicle 12 moves toward the boarding position of the user of the terminal device 13 after finishing power feeding to the power-supplied vehicle, and allows the user to board the vehicle. The boarding position may be the position of the terminal device 13 or may be a position input to the terminal device 13 by the user.

When the service provision is completed, the power supply vehicle 12 sends a completion notification indicating that the service provision has been completed to the server device 10 in S212.

In S213, the server device 10 sends billing information to the terminal device 13 in response to the completion notification. The billing information includes information indicating that a fee for power supply and service provision will be charged to a financial account registered in advance by the user. The server device 10 may send billing information to the terminal device 13 of the user of the power-supplied vehicle, or send billing information to the terminal device 13 of the user of the power-supplied vehicle and the terminal devices 13 of users around the power-supplied vehicle. If the terminal device 13 is a device used by a user of a power-supplied vehicle, and an inspection and maintenance are provided as a service along with power supply to the power-supplied vehicle, the server device 10 transmits billing information for power supply and service fees to the terminal device. Send to 13. Alternatively, in a case where ride sharing is provided as a service to different users around the power-supplied vehicle in addition to power feeding to the power-supplied vehicle, the server device 10 sends billing information for power feeding and service fees to different terminal devices 13. In either case, the server device 10 can send billing information in which the fee for providing the service is discounted from the regular fec. By doing so, it becomes possible to stimulate users' desire to use the service in the long term. In addition, it is possible to secure profit opportunities not only through power supply by the power supply vehicle 12 but also through service provision.

In S214, the terminal device 13 sends billing confirmation information to the server device 10. The terminal device 13 outputs billing information to the user, and upon receiving input from the user to confirm billing, sends billing confirmation information to the server device 10.

In S214, the server device 10 performs billing processing for the service fee. The server device 10 executes processing for charging the user's account, for example, in conjunction with a server of a financial institution used by the user.

By doing as described above, it is possible to increase the opportunity for the power supply vehicle 12 to obtain compensation for providing the service when or after power supply is performed to the power-supplied vehicle. Therefore, a business that performs on-demand charging using the power supply vehicle 12 can receive compensation for services other than power feeding, and thus it is possible to improve the operating rate of the power supply vehicle 12.

Although the embodiment has been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each means, each step, etc. can be rearranged so as not to be logically inconsistent, and a plurality of means, steps, etc. can be combined into one or divided.

What is claimed is:

1. A server device comprising:
a communication unit; and
a control unit that performs communication using the communication unit, wherein
the control unit instructs, when the control unit receives information requesting a service that is able to be provided along with power supply to a power-supplied vehicle from a terminal device within a predetermined range including the power-supplied vehicle, a power supply vehicle that is able to supply power to the power-supplied vehicle and that is able to provide the service to move for power supply.

2. The server device according to claim 1, wherein:
the service is maintenance or an inspection of the power-supplied vehicle that is able to be performed during power supply time of the power-supplied vehicle; and
the control unit receives information that is used to obtain the power supply time from the terminal device, and determines the power supply vehicle that is able to provide the service based on the information.

3. The server device according to claim 1, wherein:
the service is ride sharing provided to a user within the predetermined range; and
the control unit receives information including a boarding position from the terminal device, and instructs the power supply vehicle to move based on the information.

4. The server device according to claim 1, wherein the control unit performs a process that charges a user of the terminal device a fee for the service.
